(19) United States
(12) Patent Application Publication
(10) Pub. No.: US 2004/0249684 A1
(43) Pub. Date: Dec. 9, 2004

(54) Hotel/transportation reservation mechanism

(76) Inventor: Esa Karppinen, Helsinki (FI)

Correspondence Address: BIRCH STEWART KOLASCH & BIRCH, PO BOX 747, FALLS CHURCH, VA, 22040-0747, US

(21) Appl. No.: 10/481,520

(22) PCT Filed: Jun. 19, 2002
(86) PCT No.: PCT/FI02/00536

(30) Foreign Application Priority Data
Jun. 19, 2001 (FI) 20015014

(51) Int. Cl. G06F 17/60

(52) U.S. Cl. 705/5

(57) ABSTRACT

A method for handling a reservation request relating to a reservable item, such as a hotel room. An availability data provider (ADP) actively polls (4-1 . . . 4-4) providers (P1 . . . P4) of reservable items to obtain availability data and receives polling results (PR, 4-1′ . . . 4-4′) from the providers. The ADP maintains (4-5, 4-6) provider-specific availability data on the basis of the polling results. The ADP receives a reservation request (4-17, 4-37) from a client (TA1, TA2, EU1, EU2) and provides the client with a response (4-22, 4-43) to the reservation request. As a result of the active polling, accuracy of the availability data is improved.

### BACKGROUND OF THE INVENTION

The invention relates to a reservation method and system for reservable items, such as hotel rooms, travel tickets, rentable cars and the like. To keep the description compact, the invention is mainly presented in the context of hotel reservation systems. Particulars of other kinds of reservation systems are pointed out separately, where appropriate.

More particularly, the invention relates to large-scale (preferably: global) reservation systems. As used in this context, a large-scale reservation system means a system that cannot be implemented by simple many-to-many information architecture. For example, a many-to-many architecture may be sufficient in a closed reservation system comprising a small city's hotels and a few reservation points (travel agencies and the like). However, all hotels and reservation points in the world cannot be served by many-to-many architecture because the amount of traffic to be generated would be prohibitively large. In the past, attempts to solve this problem (lack of availability data) have been based on central reservation systems known as global distribution systems (GDS) that receive reservation information from some of the world's hotels and distribute that information to some of the world's reservation points. Thus each GDS implements a many-to-one-to-many architecture.

A system known as Amadeus is an example of a reservation central system for most of the world's airlines. Amadeus also provides some rudimentary availability data concerning hotels. A specific problem with Amadeus' hotel availability data is that the data is often outdated, a consequence of which is that a client's reservation request fails because a hotel to which the reservation request is sent turns out to be occupied. The problem is multiplied by the fact that not only is each night a separately reservable item but virtually all hotels offer rooms in several categories, such as single/double/suite, smoking/non-smoking, etc.

### SUMMARY OF THE INVENTION

An object of the present invention is to provide a method and a system for implementing the method so as to alleviate the above disadvantage. The object of the invention is achieved by a method and a system which are characterized by what is stated in the independent claims. The preferred embodiments of the invention are disclosed in the dependent claims.

The invention is based on the idea of polling the hotels for availability data. As used in this context, ‘polling’ means sending active availability inquiries to hotels, as opposed to the prior art technique, which is based on receiving the availability data, if any, that the hotels decide to send.

Assuming that the invention is used for handling reservation requests to hotel rooms, the invention can be implemented as a method that comprises the following steps: polling hotels to obtain availability data; receiving polling results from the hotels; and maintaining hotel-specific availability data on the basis of the polling results.

The invention can be generalized by substituting ‘reservable item’ for ‘hotel room’ and ‘provider’ for ‘hotel’, respectively. A feature common to all reservable items, as the term is used in this context, is that the item in question must be used at a specific time or period. For instance, a hotel room, flight seat or rentable car that was not used at a given time, has irrevocably lost its value for that time.

An advantage of the invention is that the reservation system operator can independently set the polling frequency to obtain a good balance between traffic expenses and losses due to outdated information.

According to a preferred embodiment of the invention, a client who is about to enter a reservation request is shown hotel-specific availability data. For example, this feature can be implemented by a traffic-light notation such that a hotel that is likely to be full is indicated by red colour; a hotel that is likely to have available rooms is shown indicated by green colour. Optionally, yellow colour can be used to indicate hotels for which reliable availability data is not known. Absolute certainty concerning the colours cannot be achieved because the hotels' reservation status changes continuously and hotels do not update the rooms' availability status in real-time. But even a simple two- or three-colour scheme helps to eliminate unsuccessful reservation requests by directing reservation requests to hotels with available rooms.

According to yet another preferred embodiment of the invention, clients can reserve hotels via several different connections using different terminal types. An ideal connection means for a stationary client is a web browser and an Internet connection, while a mobile client may reserve a hotel with a WAP (wireless application protocol) mobile phone. For clients using mobile devices with small displays it is especially important to minimize the amount of traffic generated and the number of pages displayed to the client. These goals can be achieved by maintaining hotel-specific availability data on the basis of the polling results and offering only hotels presumed to have available rooms for the client's selection.

A further reduction of generated traffic and displayed pages can be achieved by storing client-specific preference information and offering only hotels that meet the client's preference information. For instance, there is little point in offering youth hostels to senior business executives. The preference information may comprise price, recreation or communication facilities, proximity to certain locations (airport, town centre, beach . . . ), support for physical handicaps, etc.

According to another preferred embodiment of the invention, the polling is performed with a frequency that is not fixed but maintained on a per-hotel basis. The hotel-specific polling frequency is preferably adaptive. An adaptive polling frequency can be implemented by monitoring the success (or failure) rate of reservation requests to the hotel in question. A hotel that returns many unsuccessful reservation requests needs a higher polling frequency and vice versa. For example, a moving average of the success rate of reservation requests can be maintained, and the moving average acts as a basis for adjusting the polling frequency of the hotel in question. A default polling frequency can be once per day, but the frequency can be increased to several times per hour or decreased to once per week, depending on the stability of the reservation situation in each specific hotel. However, maintaining a moving average may be a simple enough algorithm for lowering the polling frequency, but there may be additional logic for increasing the polling frequency. For instance two reservation failures in a short period of time to hotel that is presumed to have available rooms may indicate a sudden change in the hotel's reservation status, whereby the polling frequency should be sharply increased.

Polling creates large amounts of telecommunication traffic. Separate availability data is needed for each combination of: 1) hotel; 2) night and 3) room type or rate. According to a further preferred embodiment of the invention, some polling can be eliminated if the result of each reservation request is also processed like a polling operation. In other words, a client's reservation request to a certain hotel is treated as a reservation for the particular client and the result (success or failure) is treated like the result of a polling operation. Treating reservation requests like polling operations produces more information for the same traffic costs, or alternatively, the next scheduled polling operation may be omitted.

### BRIEF DESCRIPTION OF THE DRAWINGS

In the following the invention will be described in greater detail by means of preferred embodiments with reference to the attached drawings, in which:

FIG. 1 is a block diagram illustrating a prior art reservation system;

FIG. 2 is a block diagram illustrating an availability data provider (ADP) according to the invention and its interfaces;

FIG. 3 is a block diagram illustrating a preferred embodiment of an ADP system according to the invention;

FIG. 4 is a signalling diagram illustrating a possible set of events in a system as shown in FIG. 2; and

FIG. 5 illustrates user interface screens displayed to a client.

### DETAILED DESCRIPTION OF THE INVENTION

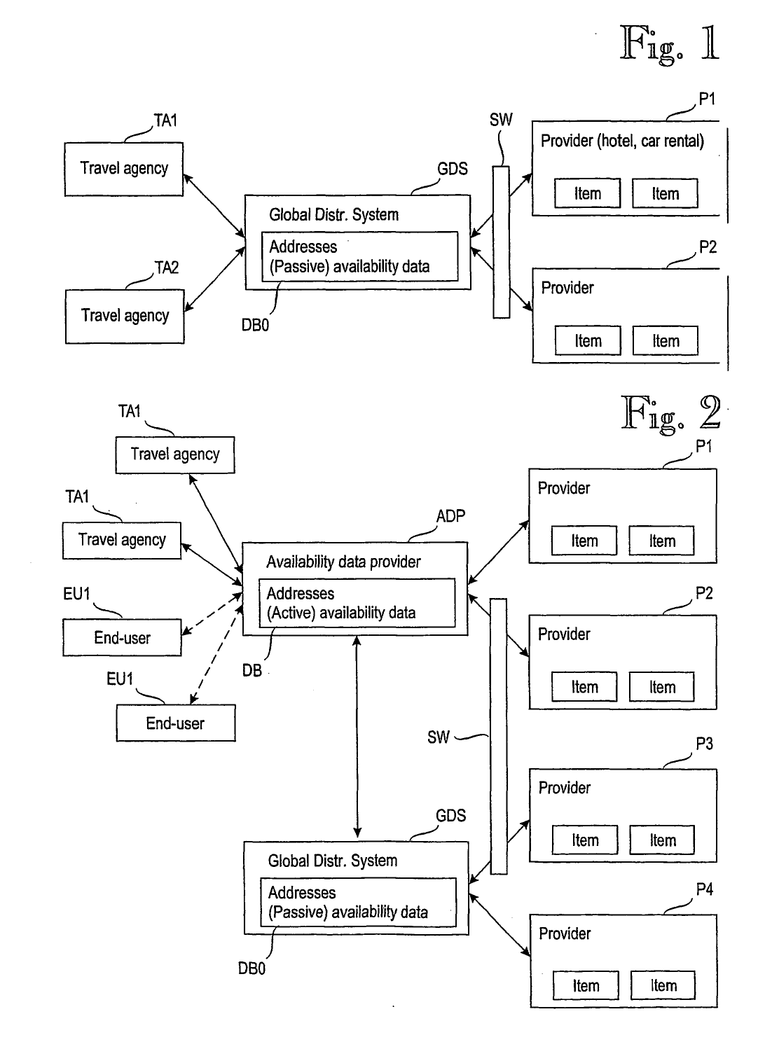

FIG. 1 is block diagram illustrating a prior art reservation system. There is a switch SW offering a centralized interface to some providers (hotels, car rentals, airlines and the like). The switch SW acts as a common gateway between travel agencies TA1, TA2, on the one hand and providers P1, P2, on the other hand. Thus the travel agencies do not have to know how to address each provider separately. In the hotel sector, Pegasus (www.pegs.com) and WizCom (www.wizcom.com) are examples of such switches.

A global distribution system GDS maintains a database DB0 containing (physical and electronic) addresses of providers P1, P2, etc. The database DB0 also contains availability data from the providers. It should be noted that each reservable item is not only a hotel room or car but a hotel room or car of a specific type or rate for a specific reservation period, the reservation period typically being a night or day. In case of flight tickets, each reservable item is a seat of a specific class (economic/business) for a specific flight. This is one of the reasons why the problem underlying the present invention differs from problems in most inventory systems. Unlike a hotel room or travel ticket, a manufactured product is not tied to a specific day or night. The best-known GDS systems operate under the names of Amadeus, Galileo, Sabre and Worldspan. A GDS is based on the idea that it receives reservation requests from the travel agencies and passes the requests to the providers. If the requested item is not available, the reservation request fails. Otherwise the item is reserved, at least temporarily. For instance, a travel agency may temporarily reserve a hotel room while checking that a convenient flight is available.

The relevant problem underlying the invention is that many reservation requests actually fail because the GDS only relies on availability data sent by the providers. Such availability data is referred to as “passive” because the GDS makes no attempt to acquire or verify it.

FIG. 2 is block diagram illustrating an availability data provider ADP according to the invention, and its interfaces. In its simplest form, the availability data provider ADP according to the invention can be implemented as a middleware element between the travel agencies TA1, TA2, and the switch SW. FIG. 2 shows an enhanced implementation in which the ADP accesses the hotels P1 to P4 via all possible combinations of the switch SW and the GDS. In this example, the ADP accesses P1 directly, P2 via the switch SW, P4 via the GDS and P3 via both the switch and the GDS.

The ADP according to the invention improves on the prior art by polling the providers P1 to P4 to obtain availability data that the ADP stores in its database DB. Such availability data is referred to as “active” because the ADP sends active inquiries to the providers. In other words, the ADP sends at least some of the active inquiries spontaneously, that is, not as a response to a specific reservation request from a client.

While it is possible to provide useful services to travel agencies by merely maintaining availability data and delivering it to the travel agencies, the ADP preferably acts as mediator for reservations (requests and acknowledgements) between the travel agencies and the providers. Thus the ADP may have interfaces not only to travel agencies but also to end users EU1, EU2, which may attach to the ADP via the Internet or a cellular mobile network.

According to a further preferred embodiment of the invention, each reservation request is also treated as a polling operation whereby, for example, the next scheduled polling operation to the same item type from the same provider can be omitted.

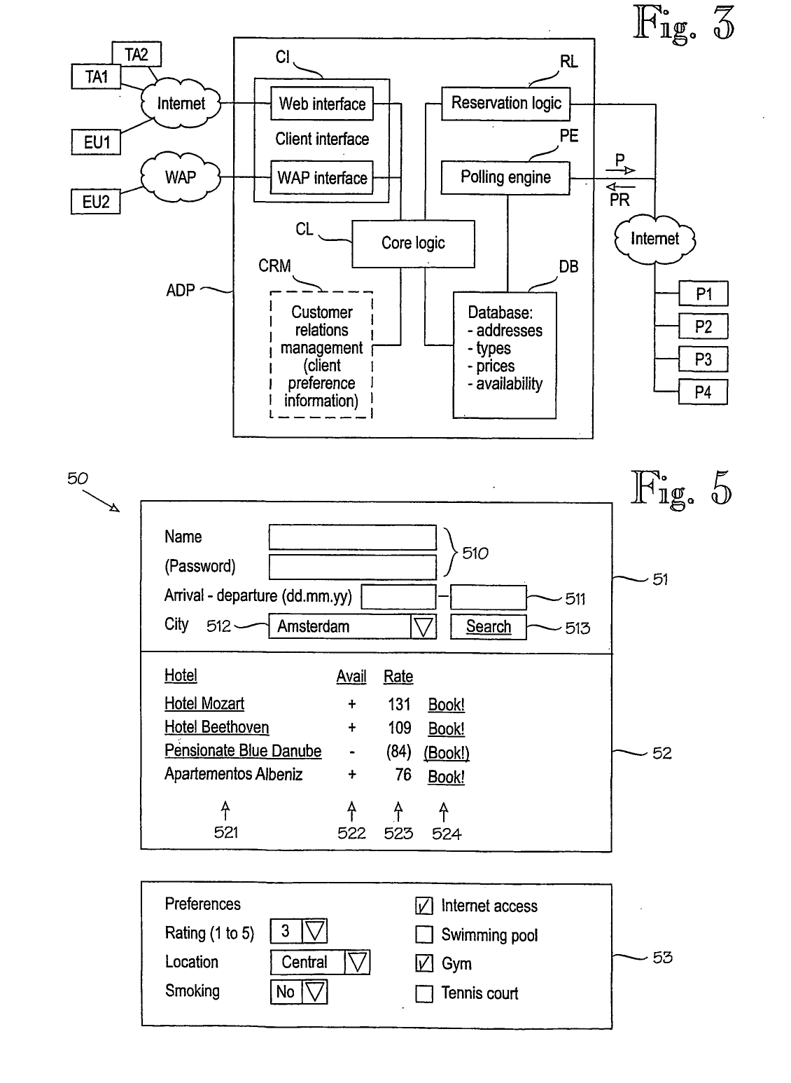

FIG. 3 is block diagram illustrating a preferred embodiment of an availability data provider ADP according to the invention. Its major functional blocks are a core logic CL, a client interface Cl, a database DB, a polling engine PE and a reservation logic RL. Preferably, the ADP also comprises a customer relations management block CRM for maintaining customer-related preference information, as will be described later in more detail. Each of the major functional blocks can be implemented by a suitably programmed general-purpose computer or a cluster of computers. The polling engine PE must be dimensioned according to the number of hotels connected to the ADP and the desired polling frequency. The remaining blocks must be dimensioned according to the reservation traffic.

The ADP serves its clients via the client interface Cl. In the example shown in FIG. 3, the client interface comprises a web interface for serving clients using a web browser and a WAP interface for serving clients using WAP mobile phones. FIG. 3 shows four clients, namely travel agencies TA1 and TA2 and end-users EU1 and EU2. EU2 uses a WAP phone, the remaining clients use a web browser and an Internet connection. In this example, all communication between the ADP and the providers (hotels) P1 to P4 takes place via the Internet, and the optional GDS is not shown. The arrow P denotes the polling operations and PR denotes the polling results.

The core logic CL contains the central processing within the ADP. It receives messages from the clients via the client interface, processes the clients' messages and decides what action to take. For instance, if the client message is a reservation request, it is passed on to the reservation logic RL that further conveys it to a specific provider.

The polling engine PE is the ADP's principal departure from prior art reservation systems. The polling engine sends polls (active inquiries) to the providers to obtain polling results. Normally, the polls are not related to a specific client's reservation request but they are sent spontaneously.

It is easy to see that polling a substantial part of the world's hotels, car rentals or the like creates huge amounts of traffic. For example, there are hundreds of thousands of hotels, each offering several types of rooms (single, double, suite, smoking/non-smoking, etc.) In addition, each combination of a room type and reservation period (such as a specific night) constitutes a separate item. A good balance of information correctness versus telecommunication expenses can be obtained if the polling engine is adaptive. This means that the polling is not performed at a fixed frequency but at a frequency that varies according to the success rate of past reservation requests. For example, if history shows that a reservation requests to a hotel fail at a rate exceeding the average failure rate, the hotel's polling frequency should be increased and vice versa.

Preferably, the ADP also comprises several conversion routines for converting between different conventions. Conversion between different currencies is a natural example. In addition, there may be a conversion rule for converting between different hotel classifications (such as from a five-star system to a numerical scale of 1 to 10 or vice versa). Some hotels may not offer triple rooms per se but do offer double rooms with an extra bed, etc.

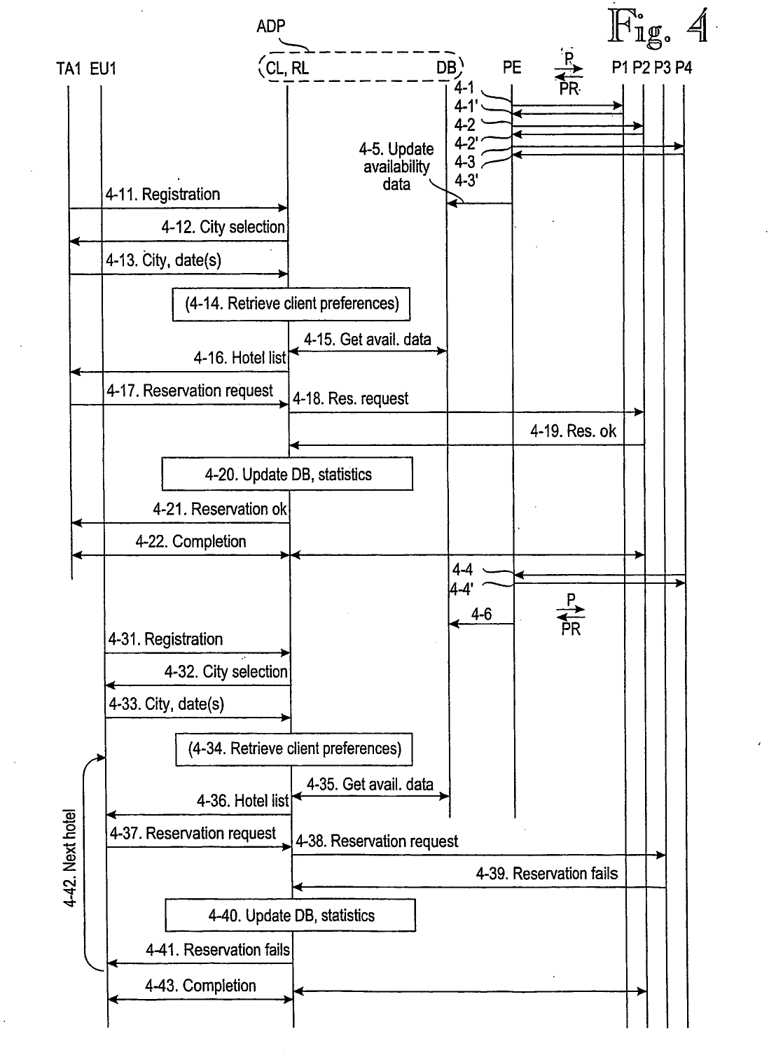

FIG. 4 is a signalling diagram illustrating a possible set of events in a system as shown in FIG. 2. The signalling diagram involves a travel agency TA1, an end-user EU1, the availability data provider ADP according to the invention, four providers P1 to P4 (which are assumed to be hotels) and, optionally, a global distribution system GDS. In step 4-1 through 4-3, the ADP polls the hotels P1 to P4 for available rooms. In steps with equal but primed numbers 4-1′ through 4-3′ the ADP obtains polling results from the hotels.

In the example shown in FIG. 2, the hotels P1 to P4 were polled via various combinations (none, either, both) of the switch and GDS. In FIG. 4, the optional switch and GDS are not shown separately because they provide little or no added value, apart from forming a centralized interface.

Actually, in the example shown, hotel P3 is not polled during the polling period shown in FIG. 4 because FIG. 4 shows a preferred feature of the invention, according to which the polling frequency is not fixed but maintained on a per-hotel basis. In this example, the availability data of hotel P3 has been so stable that up to now, it has been polled less frequently than the other hotels P1, P2 and P4.

Note that the polling steps 4-1 through 4-3 are not performed in response to any specific client action but the polling engine PE (see FIG. 3) performs the polling spontaneously. The ADP stores the polling results (hotel availability data) in the database DB (see FIGS. 2 and 3).

Next the ADP begins to serve a client, which in this case is an operator of travel agency TA1. Steps 4-11 through 4-22 relate to a hotel reservation operation. The steps shown in FIG. 4 are somewhat simplified in order to better illustrate the actual invention. In step 4-11, the client sends her registration information. In step 4-12 she is presented a city selection form. In step 4-13, the client selects a city and the date(s) for hotel reservation. Step 4-14 relates to yet another preferred feature of the invention, according to which the ADP stores client preference information in its CRM database (see FIG. 3), which can be used as a further selection means for hotels. If the client in question is a new client, she may be displayed a preference form for entering personal preference information (see item 53 in FIG. 5). In step 4-15, the ADP consults its database DB for availability data (polling results 4-1′ through 4-3′) of hotels in the city selected by the client. In step 4-16, the client is shown a list of the hotels in that city. According to another preferred feature of the invention, the list of hotels shown to the client is complemented with traffic lights or other indicators that show whether each hotel is presumed to have available rooms during the date(s) indicated by the client. By showing the presumed availability data prior to receiving the client's reservation request, time and telecommunication resources are saved because the client can choose among hotels that presumably have available rooms.

In step 4-17, the ADP receives the client's reservation request that indicates a specific hotel, room type and date(s). Optionally, the reservation request may indicate the client's further preferences (that are not found in the preferences database CRM). For instance, a client that normally prefers centrally located hotels may require a beach hotel for her holiday. Let us assume that the client selected hotel P2. In step 4-18, the ADP passes on the reservation request to hotel P2. In step 4-19, hotel P2 confirms the reservation.

According to another preferred feature of the invention, the reservation attempt (steps 4-18 and 4-19) is also treated as a polling operation. For instance, the next scheduled polling operation may be omitted or postponed. Thus in an optional step 4-20, the ADP uses the result of the reservation request to update its availability database DB. The ADP may also use the result of the reservation request to update statistic information concerning the reservation success rate of hotel P2. As an example of such statistic information, the ADP may compute a moving average of the success rate of reservation requests made to hotel P2. Such statistics information may be used to adjust a hotel-specific polling frequency. Hotels with many reservation failures need to have a higher polling frequency, and vice versa.

In step 4-21, the success of the reservation is indicated to the client. Step 4-22 comprises whatever acts are needed to complete the transaction.

Steps 4-4 and 4-4′ relate to an embodiment in which the polling frequency is maintained on a per-hotel basis. In this example, prior reservation history shows that hotel P4's reservation status changes so frequently that it needs to be polled more frequently than the other hotels. Thus in step 4-4, hotel P4 is polled again, and it responds in step 4-4′.

Steps 4-31 through 4-43 relate to serving another client, which in this case is an end-user EU1. Steps 4-31 through 4-38 correspond to steps 4-11 through 4-18, respectively, and will not be described again. However, the client EU1 has selected hotel P3, which has not been polled during the period of time shown in FIG. 4. Hotel P3 turns out to be full, and a reservation failure is indicated to the ADP in step 4-39. In step 4-40, the ADP updates its database DB and statistic information, such as the moving average of success rate of reservation. If the success rate falls below a certain threshold, the polling frequency of hotel P3 should be increased. In step 4-41, the reservation failure is indicated to the client EU1. In step 4-42, the process is returned to step 4-35 in which the ADP offers another set of hotels for selection, and the process continues until a suitable hotel is found and the process is completed in step 4-43.

FIG. 5 illustrates user interface screens displayed to a client. Reference numeral 50 generally depicts a user interface according to a preferred embodiment of the invention. A client begins a reservation process by filling in the fields 510 to 512 in section 51 of the user interface. Filling-in of these fields corresponds to steps 4-11 and 4-13 in FIG. 4. In response to the client clicking a search button 513, the ADP queries its database DB for hotels in the city 512 selected by the client, and the hotels' availability data, cf. step 4-15. The hotels and their availability status can be shown in section 52 of the user interface. The hotels are listed in column 521. In this example, underlining may be used to show that the hotel name acts as a link to further on-line information, if any. Column 522 shows the availability status for the hotels. As the traffic-light concept cannot be shown in a black-and-white drawing, plus and minus symbols are used instead. Column 523 shows the rate for the cheapest available room. The room rate for “Blue Danube” is shown in parenthesis, which is another way of showing that the ADP thinks the hotel to be full. Next to each hotel's room rate is a link to booking (making a reservation request, see steps 4-17 and 4-18) a hotel room. The booking link for “Blue Danube” is shown in parenthesis to warn the client that the hotel may be full, but the link is available, however, in case the actual availability status is better than the one indicated by the ADP.

Section 53 of the user interface may be used to enter optional client preference information in the CRM database (see FIG. 3). This preference information may be used as additional search criteria in the hotel selection step 4-14.

It will be apparent to a person skilled in the art that, as the technology advances, the inventive concept can be implemented in various ways. The invention and its embodiments are not limited to the examples described above but may vary within the scope of the claims.

1. A method for handling a reservation request relating to a reservable item; the method comprising:
polling (P, 4-1 . . . 4-4) providers (P1 . . . P4) of reservable items to obtain availability data;
receiving polling results (PR, 4-1′ . . . 4-4′) from the providers of reservable items;
maintaining (4-5, 4-6) provider-specific availability data at least partly on the basis of the polling results;
receiving a reservation request (4-17, 4-37) from a client (TA1, TA2, EU1, EU2); and
providing the client with a response (4-22, 4-41) to the reservation request;
characterized by
maintaining a provider-specific frequency for the polling;
wherein the step of maintaining the provider-specific frequency comprises calculating (4-20, 4-40) a success rate of reservation requests to the provider in question.

2. A method according to claim 1, characterized by displaying (4-16, 52) the provider-specific availability data (522) to the client prior to receiving the reservation request (4-17) from the client.

3. A method according to any one of the preceding claims, characterized by maintaining provider-specific availability data also on the basis of results (4-19, 4-39) from the reservation requests.

4. A method according to any one of the preceding claims, characterized by maintaining the provider-specific availability data per rate class.

5. A method according to any one of the preceding claims, characterized in that the reservable items comprise hotel rooms and the providers comprise hotels.

6. An apparatus (ADP) for handling reservation requests, each reservation request relating to a reservable item;
the apparatus comprising:
a polling engine (PE) for polling (P, 4-1 . . . 4-4) providers (P1 . . . P4) of reservable items to obtain availability data and for receiving polling results (PR, 4-1′ . . . 4-4′) from the providers of reservable items;
a database (DB) for maintaining (4-5, 4-6) provider-specific availability data at least partly on the basis of the polling results;
means (Cl, RL, 50) for receiving a reservation request (4-17, 4-37) from a client (TA1, TA2, EU1, EU2); and for providing the client with a response (4-22, 4-43) to the reservation request;
characterized in that the polling engine (PE) is operable to:
maintain a provider-specific frequency for the polling; and
determine the provider-specific frequency based on a success rate of reservation requests to the provider in question.
